(19) United States
(12) Patent Application Publication
(10) Pub. No.: US 2026/0139675 A1
(43) Pub. Date: May 21, 2026

(54) COMPRESSOR

(71) Applicant: MITSUBISHI HEAVY INDUSTRIES THERMAL SYSTEMS, LTD., Tokyo (JP)

(72) Inventors: Ryota TANAHASHI, Tokyo (JP); Kosuke UEDA, Tokyo (JP); Ichiro YOGO, Tokyo (JP)

(73) Assignee: MITSUBISHI HEAVY INDUSTRIES THERMAL SYSTEMS, LTD., Tokyo (JP)

(21) Appl. No.: 18/863,023

(22) PCT Filed: May 1, 2023
(86) PCT No.: PCT/JP2023/017035

§ 371 Date: Jul. 21, 2025

(30) Foreign Application Priority Data
May 6, 2022 (JP) 2022-076442

(51) Int. Cl. F04C 29/12; F04C 18/02

(52) U.S. Cl. CPC F04C 29/128; F04C 18/0215

(57) ABSTRACT

Provided is a compressor that can suppress a phenomenon that a gas refrigerant reversely flows from between a closed discharge valve and an end plate. The compressor includes: a fixed side end plate (211) in which a main port (213) communicating between a compression chamber for compressing a refrigerant and a discharge chamber (C2) to which the compressed refrigerant is guided is formed; and a leaf valve (610) configured to open and close a discharge port (213a) located on the discharge chamber (C2) side of the main port (213), a groove (214) is formed around the discharge port (213a) in a face of the fixed side end plate (211) where the discharge port (213a) is opened, and when the fixed side end plate (211) is planarly viewed, the groove (214) is overlapped with a portion on a free end (611) side of the leaf valve (610) in a closed state.

### TECHNICAL FIELD

The present disclosure relates to a compressor.

### BACKGROUND ART

For example, in scroll compressors, which are a type of compressors, a compression chamber in which a refrigerant is compressed and a discharge chamber to which the compressed refrigerant is guided are separated from each other by an end plate, and ports for communicating between the compression chamber and the discharge chamber are formed in the end plate. Further, to prevent a reverse flow of a refrigerant from the discharge chamber to the compression chamber via the ports, the end plate is provided with a discharge valve (leaf valve) that opens and closes a discharge port.

It is preferable for a closed discharge valve to be in close contact with the end plate in order to reliably close the discharge port. Practically, however, a slight gap may occur between the discharge valve and the end plate due to an error in dimensional accuracy of components or warping of the discharge valve caused by a long time of use. Further, it has been found that, when the pressure of the air conditioning system is made even after the operation of the compressor is stopped, the refrigerant reversely flows via the gap, and this causes a high-frequency sound to occur.

Although not intended to suppress a high-frequency sound, Patent Literature 1 discloses a technology in a rotary compressor to inject substantially spherical shots to a seal face of a port, thereby form a number of recesses each having a diameter of 0.1 μm to 10 μm and form an oil film by using the recesses, and thereby realize improved seal performance and wear resistance of the port part.

### CITATION LIST

### Patent Literature

### PTL 1

Japanese Patent Application Laid-Open No. 2008-95624

### SUMMARY OF INVENTION

### Technical Problem

However, since the recesses in Patent Literature 1 have a dimension of a diameter of 0.1 μm to 10 μm, the depth is smaller than 0.1 μm to 10 μm, and a lubricant oil may be insufficiently retained in the recesses. Nevertheless, it is still difficult to easily form deep recesses with the method of injecting substantially spherical shots to form recesses.

The present disclosure has been made in view of such circumstances and intends to provide a compressor that can suppress a phenomenon that a gas refrigerant reversely flows from between a closed discharge valve and an end plate.

### Solution to Problem

To solve the above problem, a compressor of the present disclosure employs the following solution.

That is, a compressor according to one aspect of the present disclosure includes: an end plate in which a port is formed, the port communicating between a compression chamber for compressing a refrigerant and a discharge chamber to which the compressed refrigerant is guided; and a discharge valve configured to open and close a discharge port located on the discharge chamber side of the port, a groove is formed around the discharge port in a face of the end plate where the discharge port is opened, and when the end plate is planarly viewed, the groove is overlapped with a portion on a free end side of the discharge valve in a closed state.

### Advantageous Effects of Invention

According to the present disclosure, it is possible to suppress a phenomenon that a gas refrigerant reversely flows from between a closed discharge valve and an end plate.

### BRIEF DESCRIPTION OF DRAWINGS

FIG. 1 is a longitudinal sectional view of a compressor according to one embodiment of the present disclosure.

FIG. 2 is a partial enlarged view (longitudinal sectional view) of a leaf valve and a groove and a part nearby illustrated in FIG. 1.

FIG. 3 is a planar view of a leaf valve and a groove and a part nearby according to Example 1.

FIG. 4 is a planar view of a leaf valve and a groove and a part nearby according to Example 2.

FIG. 5 is a partial enlarged view (longitudinal sectional view) of a leaf valve and a groove and a part nearby according to a modified example.

### DESCRIPTION OF EMBODIMENTS

A compressor according to one embodiment of the present disclosure will be described below with reference to the drawings.

### Overview of Compressor

A compressor 10 is a device that compresses a refrigerant containing a lubricant oil.

In the following description, although a scroll compressor in which a compression mechanism 200 and an electric motor 400 as a driving unit are accommodated in the internal space of a casing 100 that is an enclosed space is used as an example of the compressor 10 in the following description, a so-called open-type scroll compressor in which the driving unit is arranged outside the enclosed space may be used.

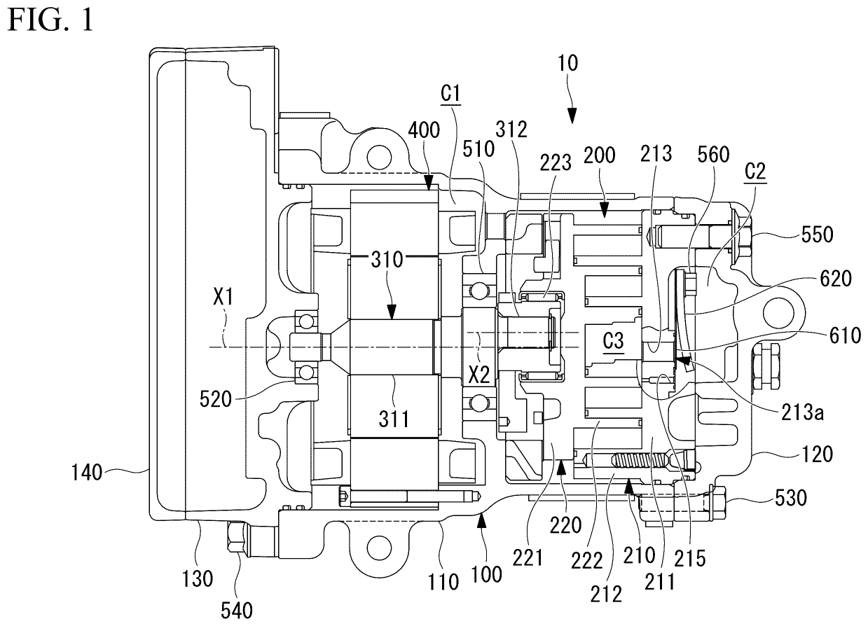

As illustrated in FIG. 1, the compressor 10 includes the casing 100, the compression mechanism 200, a crankshaft 310, and the electric motor 400.

The casing 100 has a motor case 110, an upper case 120, and a lower case 130.

The motor case 110 is a cylindrical member extending in the direction of an axis X1 and opened at both ends.

The motor case 110 surrounds the compression mechanism 200, the crankshaft 310, and the electric motor 400 about the axis X1.

The upper case 120 is a member that closes one opening of the motor case 110.

The upper case 120 is fixed to the motor case 110 by a bolt 530.

The lower case 130 is a member that closes the other opening of the motor case 110.

The lower case 130 is fixed to the motor case 110 by a bolt 540.

An inverter cover 140 is attached to the lower case 130. An inverter (not illustrated) is accommodated in a space defined by the lower case 130 and the inverter cover 140.

In an enclosed space defined by the casing 100 (the motor case 110, the upper case 120, and the lower case 130) configured as described above, the compression mechanism 200, the crankshaft 310, the electric motor 400, and various other components are accommodated.

The compression mechanism 200 is a mechanism that compresses a low-pressure gas refrigerant taken in from outside of the casing 100 through an intake port (not illustrated).

The compression mechanism 200 has a fixed scroll 210 and an orbiting scroll 220.

The fixed scroll 210 is a member having a fixed side end plate 211 and a spiral fixed side wall body 212 erected from the fixed side end plate 211.

The fixed scroll 210 is fixed to the upper case 120 by a bolt 550. Further, the outer circumferential face of the fixed side end plate 211 of the fixed scroll 210 is in contact with the inner circumferential face of the motor case 110 and the inner circumferential face of the upper case 120 while maintaining its sealing performance. Accordingly, the enclosed space inside the casing 100 is divided into an accommodation chamber C1, which is defined by the fixed scroll 210, the motor case 110, and the lower case 130, and a discharge chamber C2, which is defined by the fixed scroll 210 and the upper case 120.

Note that the sealing performance between the fixed scroll 210 and the motor case 110 and between the fixed scroll 210 and the upper case 120 is ensured by O-rings, for example.

A main port (port) 213 is formed in the fixed side end plate 211 and communicates between the discharge chamber C2 and the compression chamber C3 (described later) separated by the fixed side end plate 211.

The main port 213 is a circular hole penetrating through in the thickness direction of the fixed side end plate 211 at substantially the center of the fixed side end plate 211 (at the position corresponding to the space where the pressure of the refrigerant in the compression chamber C3 is the highest).

The face on the discharge chamber C2 side of the fixed side end plate 211 is provided with a leaf valve (discharge valve) 610 and a retainer 620 to restrict the amount of bending of the leaf valve 610. The detailed structure of the leaf valve 610 and the part nearby will be described later.

The orbiting scroll 220 is a member having an orbiting side end plate 221 and a spiral orbiting side wall body 222 erected from the orbiting side end plate 221.

The orbiting scroll 220 is configured to perform revolution movement with respect to the fixed scroll 210 by the crankshaft 310 rotated about the axis X1 (in detail, a crankpin 312 revolved about the axis X1) and a known anti-rotation mechanism.

Respective wall bodies of the fixed scroll 210 and the orbiting scroll 220 are engaged with each other, and thereby the fixed scroll 210 and the orbiting scroll 220 form a compression chamber C3.

The crankshaft 310 is a member for transmitting driving force from the electric motor 400 to the orbiting scroll 220.

The crankshaft 310 has a shaft body 311 and the crankpin 312.

The shaft body 311 is a shaft-like member extending along the axis X1. The shaft body 311 is driven and rotated about the axis X1 by the electric motor 400.

The shaft body 311 is supported rotatably about the axis X1 by a main bearing 510, which is fixed to the motor case 110, and a sub-bearing 520, which is fixed to the lower case 130.

The crankpin 312 is a shaft-like member provided at an end on the upper case 120 side of the shaft body 311.

The crankpin 312 extends along another axis X2 eccentric from the axis X1. Thus, when the shaft body 311 is rotated about the axis X1, the crankpin 312 is revolved about the axis X1.

The crankpin 312 is connected via a bearing 223 to a boss part formed in the orbiting scroll 220.

The compressor 10 configured as described above is driven as follows.

That is, the shaft body 311 of the crankshaft 310 is driven and rotated about the axis X1 by the electric motor 400, and thereby the orbiting scroll 220 connected to the crankpin 312 is driven.

A gas refrigerant taken into the accommodation chamber C1 on the lower case 130 side via the intake port (not illustrated) passes through a refrigerant passage or the like formed between the inner circumferential face of the motor case 110 and the outer circumferential face of the electric motor 400 (stator) and is guided to the accommodation chamber C1 on the compression mechanism 200 side.

The refrigerant that has been guided to the accommodation chamber C1 on the compression mechanism 200 side is taken into the compression chamber C3. At this time, since the compression chamber C3 is configured so that the volume thereof is gradually reduced in accordance with the revolution movement of the orbiting scroll 220, the gas refrigerant is compressed accordingly.

The compressed high-temperature high-pressure gas refrigerant is guided to the discharge chamber C2 through the main port 213 provided at substantially the center of the fixed side end plate 211 of the fixed scroll 210.

The gas refrigerant that has been guided to the discharge chamber C2 is discharged to outside of the compressor 10 via the discharge port (not illustrated) provided in the upper case 120.

### Structure of Leaf Valve and Part Nearby

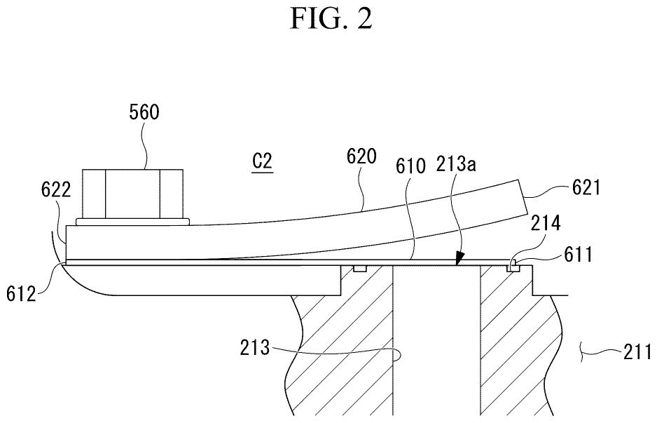

As illustrated in FIG. 1 and FIG. 2, the leaf valve 610 and the retainer 620 are provided to the fixed side end plate 211 on the discharge chamber C2 side.

The leaf valve 610 is a thin plate-like member (valve) that opens and closes the opening on the outlet side (the discharge port 213a) of the main port 213.

The retainer 620 is a plate-like member provided so as to be overlapped on the leaf valve 610.

The base end 622 of the retainer 620 is fixed to the fixed side end plate 211 by a bolt 560 with the base end 612 of the leaf valve 610 being interposed between the base end 622 and the fixed side end plate 211.

Accordingly, the leaf valve 610 is fixed to the fixed side end plate 211 together with the retainer 620.

The free end 621 of the retainer 620 is located above the base end 622, and the external shape of the retainer 620 has a form gradually warping upward from the base end 622 to the free end 621 in side view.

The leaf valve 610 closes the discharge port 213a when the compressor 10 is not in operation, and once the operation of the compressor 10 is started and the pressure of the refrigerant in the compression chamber C3 becomes above a predetermined pressure, the free end 611 is bent while warping upward, and thereby the leaf valve 610 opens the discharge port 213a. The refrigerant then flows from the compression chamber C3 into the discharge chamber C2 via the main port 213. At this time, the amount of bending of the leaf valve 610 is restricted by the retainer 620.

Further, when the pressure of the compression chamber C3 decreases, the leaf valve 610 returns to the original position and again closes the discharge port 213a.

That is, during the operation of the compressor 10, the free end 611 of the leaf valve 610 will repeat reciprocating movement between the fixed side end plate 211 and the retainer 620.

In the leaf valve 610 configured in such a way, a slight gap may occur between the leaf valve 610 and the fixed side end plate 211 due to an error in dimensional accuracy of components or the warping of the leaf valve 610 caused by a long time of use. Further, when the pressure of the air conditioning system is uniformed after the operation of the compressor is stopped, the refrigerant may reversely flow via the gap, and this may cause a high-frequency sound to occur.

Accordingly, in the present embodiment, to suppress the reverse flow of the gas refrigerant, the groove 214 is formed in the fixed side end plate 211.

The configuration of the groove 214 will be described below with reference to a plurality of Examples.

### EXAMPLE 1

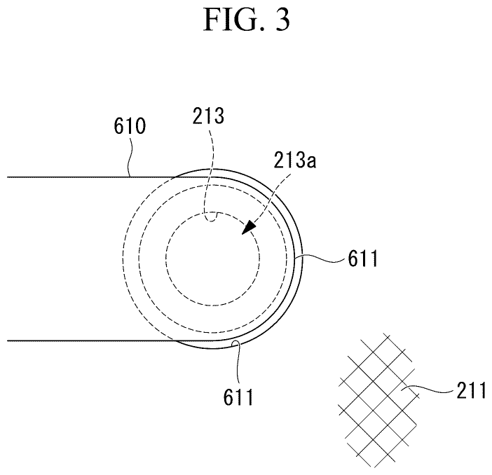

As illustrated in FIG. 2 and FIG. 3, the groove 214 is formed in a face of the fixed side end plate 211 contacted with the closed leaf valve 610.

The groove 214 is formed around the discharge port 213a that is circular in planar view. In detail, the groove 214 is formed over the entire circumference of the discharge port 213a and circumferentially along the discharge port 213a. That is, the groove 214 is circularly annular. In this example, it is preferable that the center of the discharge port 213a and the center of the groove 214 be the same (see FIG. 3).

As illustrated in FIG. 2, the groove 214 is recessed in substantially a U-shape from the face of the fixed side end plate 211 (the top face in FIG. 2) in the longitudinal cross section. In the groove 214, the maximum value of the depth dimension is greater than or equal to 0.5 mm and less than or equal to 1.0 mm, and the maximum value of the width dimension is greater than or equal to 0.5 mm and less than or equal to 1.0 mm.

In this example, as illustrated in FIG. 3, the semi-circular arc-shaped free end 611 of the leaf valve 610 is overlapped with the circular, annular groove 214 (in detail, with a part of the groove 214 corresponding to the position of the semi-circular arc-shaped portion on the free end 611 side of the real valve 610) when the fixed side end plate 211 is planarly viewed.

That is, the groove 214 is designed such that the position thereof is overlapped with the free end 611 of the leaf valve 610. Alternatively, the leaf valve 610 is designed such that the free end 611 thereof is overlapped with the groove 214.

### EXAMPLE 2

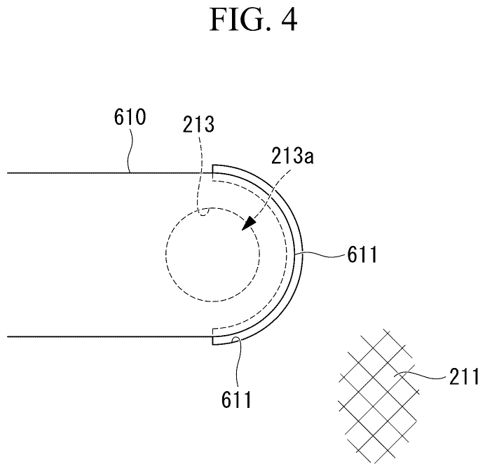

As illustrated in FIG. 4, the groove 214 is formed around the discharge port 213a that is circular in planar view. In detail, the groove 214 is formed over a half of the circumference of the discharge port 213a and circumferentially along the discharge port 213a. That is, the groove 214 is semi-circularly annular. In this example, it is preferable that the center of the discharge port 213a and the center of the groove 214 be the same (see FIG. 4).

In this example, as illustrated in FIG. 4, the semi-circular arc-shaped free end 611 of the leaf valve 610 is overlapped with the semi-circular, annular groove 214 when the fixed side end plate 211 is planarly viewed. This is the same as Example 1.

Note that, although the groove 214 is semi-circularly annular (with an angle of 180 degrees) in Example 2, the groove 214 may be formed with an angle exceeding 180 degrees as long as it is overlapped with the semi-circular arc-shaped free end 611 of the leaf valve 610 (when the angle is 360 degrees, Example 1 is resulted).

Herein, as illustrated in FIG. 2, in Example 1 and Example 2, the free end 611 of the leaf valve 610 overlapped with the circular annular groove 214 is not necessarily required to fully cover the groove 214 corresponding to the position on the free end 611 side but may cover at least a part of the groove 214.

However, it is preferable that the free end 611 of the leaf valve 610 reach a position at a half of the groove 214 corresponding to the position on the free end 611 side.

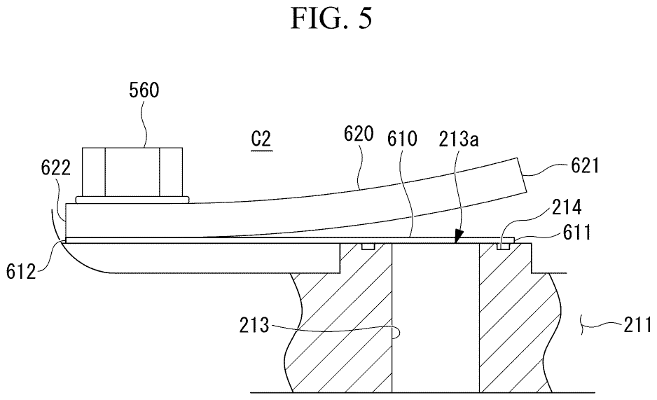

Further, as illustrated in FIG. 5, the free end 611 of the leaf valve 610 may fully cover the groove 214.

According to the present embodiment, the following advantageous effects are achieved.

The groove 214 is formed around the discharge port 213a in the face of the fixed side end plate 211 where the discharge port 213a is opened, and the groove 214 is overlapped with a portion on the free end 611 side of the closed leaf valve 610 when the fixed side end plate 211 is planarly viewed. Thus, the lubricant oil contained in the refrigerant is retained in the groove 214, and the leaf valve 610 and the fixed side end plate 211 will be in close contact with each other by the lubricant oil having surface tension. Accordingly, seal between the leaf valve 610 and the fixed side end plate 211 is ensured by the lubricant oil, and this can prevent the phenomenon that the refrigerant gas reversely flows from between the leaf valve 610 in the closed state and the fixed side end plate 211.

Further, when the groove 214 is formed over at least a half of the circumference of the discharge port 213a, efficient seal between the leaf valve 610 and the fixed side end plate 211 can be ensured in particular on the free end 611 side that is more affected by warping of the leaf valve 610.

Further, when the groove 214 is formed over the entire circumference of the discharge port 213a, more reliable seal between the leaf valve 610 and the fixed side end plate 211 can be ensured.

Further, when the depth dimension of the groove 214 is greater than or equal to 0.5 mm and less than or equal to 1.0 mm, the lubricant oil can be sufficiently retained in the groove 214.

Further, when the maximum value of the width dimension of the groove 214 is greater than or equal to 0.5 mm and less than or equal to 1.0 mm, the lubricant oil can be sufficiently retained in the groove 214.

Herein, the configuration of the groove 214 described above may be applied not only to the main port 213 but also to a multi-port (further port) 215 formed in the fixed side end plate 211 in order to prevent over-compression.

As illustrated in FIG. 1, the multi-port 215 is a circular hole penetrating through in the thickness direction of the fixed side end plate 211 in a portion of the fixed side end plate 211 on the outer circumferential side of the main port 213.

Further, although not illustrated, the multi-port 215 is also provided with components corresponding to the leaf valve 610 and the retainer 620.

Note that the multi-port 215 illustrated in FIG. 1 is depicted at a different position from the actual position for illustrative purposes.

The compressor according to one embodiment described above is understood as follows, for example.

That is, a compressor (10) according to the first aspect of the present disclosure includes: an end plate (211) in which a port (213) is formed, the port communicating between a compression chamber (C3) for compressing a refrigerant and a discharge chamber (C2) to which the compressed refrigerant is guided; and a discharge valve (610) configured to open and close a discharge port (213a) located on the discharge chamber side of the port, a groove (214) is formed around the discharge port in a face of the end plate where the discharge port is opened, and when the end plate is planarly viewed, the groove is overlapped with a portion on a free end (611) side of the discharge valve in a closed state.

According to the compressor of the present aspect, a groove is formed around the discharge port in a face of the end plate where the discharge port is opened, and the groove is overlapped with a portion on a free end side of the closed discharge valve when the end plate is planarly viewed. Thus, the lubricant oil contained in the refrigerant is retained in the groove, and the discharge valve and the end plate will be in close contact with each other by the lubricant oil having surface tension. Accordingly, seal between the discharge valve and the end plate is ensured by the lubricant oil, and this can prevent the phenomenon that the refrigerant gas reversely flows from between the discharge valve in the closed state and the end plate.

Further, in the compressor according to the second aspect of the present disclosure, in the first aspect, a further port (215) communicating between the compression chamber and the discharge chamber is formed in the end plate, the compressor further includes: a further discharge valve configured to open and close a further discharge port located on the discharge chamber side of the further port, a further groove is formed around the further discharge port in a face of the end plate where the further discharge port is opened, and when the end plate is planarly viewed, the further groove is overlapped with a portion on a free end side of the further discharge valve in a closed state.

According to the compressor of the present aspect, the phenomenon of a reverse flow of a refrigerant gas can be prevented not only for a single port but also for a further port.

Further, in the compressor according to the third aspect of the present disclosure, in the first aspect, the groove is formed over at least a half of the circumference of the discharge port on the free end side of the discharge valve.

According to the compressor of the present aspect, since the groove is formed over at least a half of the circumference of the discharge port on the free end side of the discharge valve, efficient seal between the discharge valve and the end plate can be ensured in particular on the free end side that is more affected by warping of the discharge valve.

Further, in the compressor according to the fourth aspect of the present disclosure, in the first aspect, the groove is formed over the entire circumference of the discharge port.

According to the compressor of the present aspect, since the groove is formed over the entire circumference of the discharge port, more reliable seal can be ensured between the discharge valve and the end plate.

Further, in the compressor according to the fifth aspect of the present disclosure, in any one of the first aspect to the fourth aspect, the maximum value of the depth dimension of the groove is greater than or equal to 0.5 mm and less than or equal to 1.0 mm.

According to the compressor of the present aspect, since the depth dimension of the groove is greater than or equal to 0.5 mm and less than or equal to 1.0 mm, the lubricant oil can be sufficiently retained in the groove.

Further, in the compressor according to the sixth aspect of the present disclosure, in any one of the first aspect to the fifth aspect, the maximum value of the width dimension of the groove is greater than or equal to 0.5 mm and less than or equal to 1.0 mm.

According to the compressor of the present aspect, since the maximum value of the width dimension of the groove is greater than or equal to 0.5 mm and less than or equal to 1.0 mm, the lubricant oil can be sufficiently retained in the groove.

Further, in the compressor according to the seventh aspect of the present disclosure, in any one of the second aspect to the sixth aspect, the further groove is formed over at least a half of the circumference of the further discharge port on the free end side of the further discharge valve.

According to the compressor of the present aspect, since the further groove is formed over at least a half of the circumference of the further discharge port on the free end side of the further discharge valve, efficient seal between the discharge valve and the end plate can be ensured in particular on the free end side that is more affected by warping of the discharge valve.

Further, in the compressor according to the eighth aspect of the present disclosure, in any one of the second aspect to the sixth aspect, the further groove is formed over the entire circumference of the further discharge port.

According to the compressor of the present aspect, since the further groove is formed over the entire circumference of the further discharge port, more reliable seal can be ensured between the discharge valve and the end plate.

Further, in the compressor according to the ninth aspect of the present disclosure, in any one of the second aspect to the eighth aspect, the maximum value of the depth dimension of the further groove is greater than or equal to 0.5 mm and less than or equal to 1.0 mm.

According to the compressor of the present aspect, since the depth dimension of the further groove is greater than or equal to 0.5 mm and less than or equal to 1.0 mm, the lubricant oil can be sufficiently retained in the groove.

Further, in the compressor according to the tenth aspect of the present disclosure, in any one of the second aspect to the ninth aspect, the maximum value of the width dimension of the further groove is greater than or equal to 0.5 mm and less than or equal to 1.0 mm.

According to the compressor of the present aspect, since the maximum value of the width dimension of the further groove is greater than or equal to 0.5 mm and less than or equal to 1.0 mm, the lubricant oil can be sufficiently retained in the groove.

### REFERENCE SIGNS LIST

10 compressor
100 casing
110 motor case
120 upper case
130 lower case
140 inverter cover
200 compression mechanism
210 fixed scroll
211 fixed side end plate
212 fixed side wall body
213 main port (port)
213a discharge port
214 groove
215 multi-port (port, further port)
220 orbiting scroll
221 orbiting side end plate
222 orbiting side wall body
223 bearing
310 crankshaft
311 shaft body
312 crankpin
400 electric motor
510 main bearing
520 sub-bearing
530 bolt
540 bolt
550 bolt
560 bolt
610 leaf valve (discharge valve)
611 free end
612 base end
620 retainer
621 free end
622 base end
C1 accommodation chamber
C2 discharge chamber
C3 compression chamber
X1 axis
X2 axis

1. A compressor comprising:
an end plate in which a port is formed, the port communicating between a compression chamber for compressing a refrigerant and a discharge chamber to which the compressed refrigerant is guided; and
a discharge valve configured to open and close a discharge port located on the discharge chamber side of the port,
wherein a groove is formed around the discharge port in a face of the end plate where the discharge port is opened, and
wherein when the end plate is planarly viewed, the groove is overlapped with a portion on a free end side of the discharge valve in a closed state.

2. The compressor according to claim 1,
wherein a further port communicating between the compression chamber and the discharge chamber is formed in the end plate,
the compressor further comprising:
a further discharge valve configured to open and close a further discharge port located on the discharge chamber side of the further port,
wherein a further groove is formed around the further discharge port in a face of the end plate where the further discharge port is opened, and
wherein when the end plate is planarly viewed, the further groove is overlapped with a portion on a free end side of the further discharge valve in a closed state.

3. The compressor according to claim 1, wherein the groove is formed over at least a half of the circumference of the discharge port on the free end side of the discharge

4. The compressor according to claim 1, wherein the groove is formed over the entire circumference of the discharge port.

5. The compressor according to claim 1, wherein the maximum value of the depth dimension of the groove is greater than or equal to 0.5 mm and less than or equal to 1.0 mm.

6. The compressor according to claim 1, wherein the maximum value of the width dimension of the groove is greater than or equal to 0.5 mm and less than or equal to 1.0 mm.

7. The compressor according to claim 2, wherein the further groove is formed over at least a half of the circumference of the further discharge port on the free end side of the further discharge valve.

8. The compressor according to claim 2, wherein the further groove is formed over the entire circumference of the further discharge port.

9. The compressor according to claim 2, wherein the maximum value of the depth dimension of the further groove is greater than or equal to 0.5 mm and less than or equal to 1.0 mm.

10. The compressor according to claim 2, wherein the maximum value of the width dimension of the further groove is greater than or equal to 0.5 mm and less than or equal to 1.0 mm.
